(19) United States
(12) Patent Application Publication
(10) Pub. No.: US 2014/0344108 A1
(43) Pub. Date: Nov. 20, 2014

(54) Gift Card Registry System

(71) Applicant: Kinoli, Inc., Windsor, CO (US)

(72) Inventor: Luke A. Knowles, Fort Collins, CO (US)

(73) Assignee: Kinoli, Inc., Windsor, CO (US)

(21) Appl. No.: 14/278,781

(22) Filed: May 15, 2014

Related U.S. Application Data
(60) Provisional application No. 61/823,680, filed on May 15, 2013.

(51) Int. Cl. G06Q 30/06; G06Q 20/28

(52) U.S. Cl. CPC G06Q 30/0633; G06Q 20/28
USPC 705/26.8

(57) ABSTRACT

An on-line gift card registry which includes a gift card registry program which functions to format and download a user interface which allows a registrant to create a gift card registry including gift cards of selected merchants and assign a gift card value to each gift card, and which allows each of a plurality of giftors to purchase gift cards of the selected merchants until the gift card value has been met for each one of the gift cards within the gift card registry.

This United States Non-Provisional Patent Application claims the benefit of U.S. Provisional Patent Application No. 61/823,680, filed May 15, 2013, hereby incorporated by reference herein.

### I. BACKGROUND

An on-line gift card registry which includes a gift card registry program which functions to format and download a user interface which allows a registrant to create a gift card registry including gift cards of selected merchants and assign a gift card value to each gift card, and which allows each of a plurality of giftors to purchase gift cards of the selected merchants until the gift card value has been met for each one of the gift cards within the gift card registry.

### II. SUMMARY OF THE INVENTION

A broad object of the invention can be to provide an on-line gift card registry system in the form of a computer-readable medium having computer-executable instructions contained in a computer server executable to format and download to one or more client computers a gift card registry registrant interface interactive with a registrant to create a gift card registry of selected one or more registry gift cards of registry merchants and associated with each of the one or more registry gift cards at a registry gift card requested value and further executable to format and download to one or more client computers a gift card registry giftor interface interactive with a giftor to select one or more of the registry gift cards associated with the gift card registry of the registrant and to associate a registry gift card purchase value to selected one or more of the registry gift cards and to purchase one or more registry gift cards each having the registry gift card purchase value deducted from the registry gift card requested value to associate a registry gift card unmet value with each of the selected one or more registry gift cards.

Another broad object of the invention can be to provide computer elements and network elements with the computer elements being programmed to implement a gift card registry registrant interface which depicts one or more registry gift cards (or other indicia representing the one or more registry gift cards) of registry merchants and an associated registry gift card request value field fillable with a registry gift card request value which by click event (also referred to as “user interaction”) in the graphic user interface associates the selected one or more registry gift cards along with the registry gift card request value with the gift card registry of the registrant.

Another broad object of the invention can be to provide computer elements and network elements with the computer elements being programmed to implement a gift card registry giftor interface which depicts the one more registry gift cards associated with a gift card registry of a registrant which by click event can be selected for purchase as a gift and associated with a registry gift card purchase value and with confirmation of a purchase of a registry gift card, the registry gift card purchase value can be deducted from the registry gift card request value resulting in a subsequently depicted reduction in a registry merchant request unmet value.

Naturally, further objects of the invention are disclosed throughout other areas of the specification, drawings, and claims.

### III. A BRIEF DESCRIPTION OF THE DRAWINGS

FIG. 1 is a block diagram which illustrates exemplary computer means and network means which can be utilized to practice various embodiments of the on-line gift card registry system.

FIG. 2 is block flow diagram of an interactive user interface and method of creating a particular embodiment of an on-line gift card registry.

FIG. 3 is block flow diagram of a particular embodiment of registrant graphical user interface elements for creating a particular embodiment of an on-line gift card registry.

FIG. 4 is an illustration of a graphical interface of a particular embodiment of an on-line gift card registry.

FIG. 5 is an illustration of a graphical interface of a particular embodiment of an on-line gift card registry.

FIG. 6 is block flow diagram of a method of saving a particular embodiment of an on-line gift card registry.

FIG. 7 is a block flow diagram of an interactive user interface and a method of displaying a particular embodiment of an on-line gift card registry.

FIG. 8 is a block flow diagram of an interactive user interface and a method of processing registry gift card purchases in a particular embodiment of an on-line gift card registry.

FIG. 9 is block flow diagram of a particular embodiment of giftor graphical user interface elements for processing registry gift card purchases in a particular embodiment of an on-line gift card registry.

FIG. 10 is an illustration of a graphical interface of a particular embodiment of an on-line gift card registry.

FIG. 11 is an illustration of a graphical interface of a particular embodiment of an on-line gift card registry.

FIG. 12 is an illustration of a graphical interface of a particular embodiment of an on-line gift card registry.

FIG. 13 is an illustration of a graphical interface of a particular embodiment of an on-line gift card registry.

FIG. 14 is an illustration of a graphical interface of a particular embodiment of an on-line gift card registry.

FIG. 15 is an illustration of a graphical interface of a particular embodiment of an on-line gift card registry.

FIG. 16 is a block flow diagram of an interactive user interface and a method of processing registry gift card purchases following a registry gift card purchase in a particular embodiment of an on-line gift card registry.

FIG. 17 is an illustration of a graphical interface of a particular embodiment of an on-line gift card registry.

FIG. 18 is a block flow diagram of a particular embodiment of graphical user interface elements for processing gift card purchases following a gift card purchase in a particular embodiment of an on-line gift card registry.

### IV. DETAILED DESCRIPTION OF THE PREFERRED EMBODIMENTS

Generally, an on-line gift card registry system including a server-accessible gift card registry program (also referred to as “a computer code”) which allows a registrant to create a gift card registry accessible by plurality of giftors to purchase one or more registry gift cards from registry merchants included in or associated with the gift card registry of the registrant as a gift for the registrant giftee.

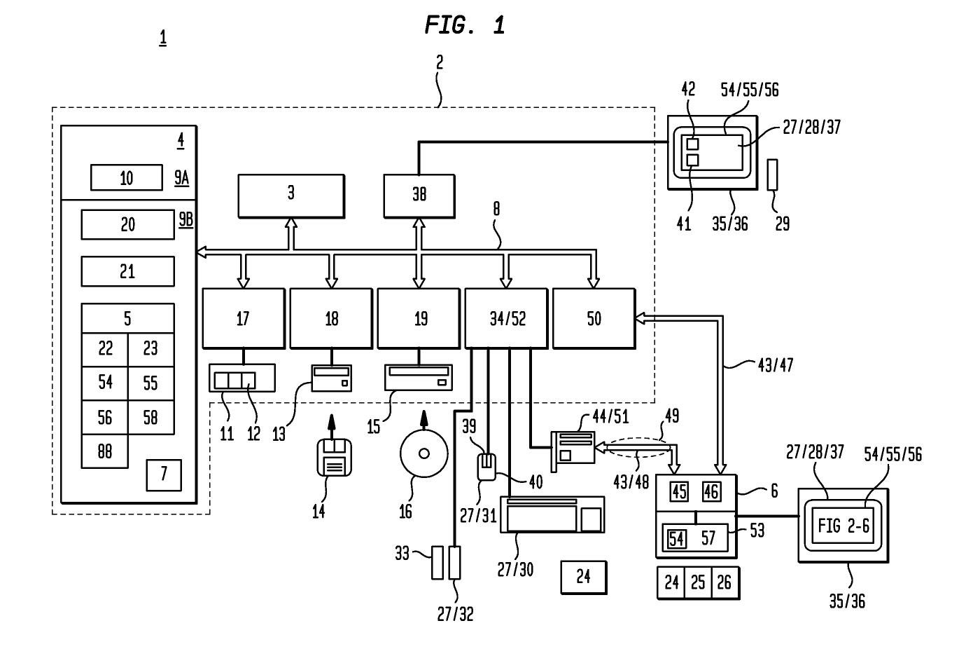

Now referring primarily to FIG. 1, which provides an overview of certain computer elements and certain network elements which can be utilized to practice various embodiments of the on-line gift card registry system (1). While the computer elements and the network elements shown in FIG. 1 can be utilized to practice exemplary embodiments of the invention including the best mode, it is not intended that the description of the best mode of the invention or any exemplary embodiment of the invention be limiting with respect to the utilization of a wide variety of similar, different, or equivalent computer elements or network elements to practice embodiments of the invention which include without limitation hand-held devices, such as personal digital assistants or cameras/cell phones, multiprocessor systems, microprocessor-based or programmable consumer electronics, network personal computers, minicomputers, mainframe computers, or the like.

Similarly, it is not intended that embodiments of the invention be practiced in only local computing environments but rather the invention can be practiced in local computing environments or in distributed computing environments where functions or tasks are performed by remote processing devices that are linked through a communications network. In a distributed computing environment, program modules may be located in local or remote memory storage devices or elements. Also, while an exemplary embodiment of the invention may be described in the general context of computer-executable instructions of a computer program having one or more program modules which include routines, procedures, or functions being executed by the computer elements or network elements, it is not intended that any embodiments of the invention be limited to a particular set of computer-executable instructions or protocols.

Again referring to FIG. 1, a server computer (2) (also referred to as a “server”) can provide a server processer (3) and a server memory element (4) containing a gift card registry program (5). The server computer (2) can be configured to serve the gift card registry program (5) to a plurality of client computers (6) and to store a plurality of gift card registries (7) in the server memory element (4) or other memory element (also referred to as the “gift card registry repository”).

The server computer (2) can be a conventional computer, a distributed computer, or any other type of computer; the invention is not so limited. The server processor (3) can be one central-processing unit (CPU), or a plurality of processing units which operate in parallel to process digital information. As an illustrative example, the server computer (2), the server processer (3), and the server memory element (4) containing the gift card registry program (5) can be operably connected by a bus (8). The bus (8) can be any of several types of bus configurations including a memory bus or memory controller, a peripheral bus, or a local bus using any of a variety of bus architectures. The server memory element (4) can be one or more of a read only memory (ROM) (9A), a random access memory (RAM) (9B). A basic input/output system (BIOS) (10), containing routines that assist transfer of data between the components of the server computer (2), such as during start-up, can be stored in ROM (9A). The server computer (2) can further include a hard disk drive (11) for reading from and writing to a hard disk (12), a magnetic disk drive (13) for reading from or writing to a removable magnetic disk (14), or an optical disk drive (15) for reading from or writing to a removable optical disk (16) such as a CD ROM or other optical media.

The hard disk drive (11), magnetic disk drive (13), or optical disk drive (15) can be respectively connected to the bus (8) by a hard disk drive interface (17), a magnetic disk drive interface (18), or an optical disk drive interface (19). The drives and their associated computer-readable media can provide nonvolatile storage of computer-readable instructions, data structures, program modules or other data for the server computer (2), including the gift card registry program (5). It can be appreciated by those skilled in the art that any type of computer-readable media that can store data that is accessible by a computer, such as magnetic cassettes, flash memory cards, digital video disks, Bernoulli cartridges, random access memories (RAMs), read only memories (ROMs), or the like, may be used in a variety of operating environments to implement embodiments of the on-line gift card registry system (1).

One more computer programs or program modules can be stored on the hard disk (12), magnetic disk (14), optical disk (16), ROM (9A), or RAM (9B), including an operating system (20), one or a plurality of application programs (21), including, but not limited to, the gift card registry program (5) which can include a plurality of gift card registry program modules (22) and gift card registry program data (23) which may be served by the server computer (2).

A computer user (24), whether a registrant (25) or giftor (26), as further described below, may enter commands and information into the server computer (2) through a variety of peripheral input devices (27) such as: a touch interactive surface (28) and a touch element (29), a keyboard (30) and pointing device (31) such as a mouse (40), a microphone (32) and a sound element (33). Other peripheral input devices (27) can include a camera, a scanner, a bar code reader, a joystick, a game pad, a satellite dish, or the like. The peripheral input devices (27) can be wire or wirelessly connected to the server processor (3) by an input device interface (34) coupled to the bus (8) such as a touch surface interface, a serial port interface, a universal serial bus, a dual serial/universal serial bus, a parallel port, a game port, or the like.

A variety of peripheral output devices (35) can be wire or wirelessly connected to the bus (8) of the server computer (2), including a display device (36) having a display surface (37) by a visual display device interface (38) such as a display serial interface, a display command set, a display pixel interface, a display bus interface, a stereoscopic display format, a pinch interface, a video adapter, or the like. In addition to the display device (36), other peripheral output devices (35) can be connected to the bus (8) of the server computer (2) such as speakers, printers, or the like.

The computer user (24), whether registrant (25) or giftor (26), by “click event” or “interaction” can operate a program function of an application program (21), including, but not limited to the program functions of the gift card registry program (5) through the use of a command, which for example, can include a touch on a touch interactive surface (28), pressing or releasing a left mouse button (39) of a mouse (40) while a pointer (41) is located over a control icon (42) displayed on the display surface (37) of a display device (36).

However, it is not intended that a “click event” or “interaction” be limited to a touch over a control icon (42) on a touch interactive surface (28) or the press and release of the left mouse button (39) on a mouse (40) while a pointer (41) is located over a control icon (42); rather, a “click event” is intend to broadly encompass a command by the computer user (24) which activates or operates a program function of an application program (21), including the activation or operation of a program function of the gift card registry program (5). The term “control icon” broadly includes any sensorial perceivable indicia which by computer user interaction directly or indirectly activates or operates a program function, including one or more of computer user interactive visual indicia, images, symbols, lists, or the like, or computer user interactive fields fellable with field information such as a street address, zip code, county code, or natural area code, a latitude/longitude, X and Y coordinates, or other notation, script, character, number, or the like, or computer user interactive audible indicia such as signals, sounds, phrases, words, or the like, or olfactory indicia such as odors, scents, essences, or the like, or tactile indicia such as raised or depressed or change in surface elements, embossments, patterns, impressions, taggants, vibrations, temperature, or the like.

Again referring primarily to FIG. 1, the server computer (2) may operate in a networked environment using logical connections (43), to one or more client computers (6). These logical connections (43) are achieved by one or more communications devices (44) coupled to or a part of the server computer (2); the invention is not limited to a particular type of communications device (44). The client computer (6) can include a part or all of the elements above-described relative to the server computer (2), although only a client computer processor (45) coupled to a client computer memory element (46) are illustrated in FIG. 1.

The logical connections (43) can include a local-area network (LAN) (47) or a wide-area network (WAN) (48). Such networking environments are commonplace in offices, enterprise-wide computer networks, intranets and the Internet (49). When used in a LAN (47) networking environment, the server computer (2) can be connected to the LAN (47) through a network interface (50). When used in a WAN (48) networking environment, the server computer (2) can be connect to the WAN (48) through a modem (51), or any other type of communications device (44) for establishing communications over the WAN (48), such as the Internet (49). The modem (51) typically connects to the bus (8) via a serial port interface (52).

In a LAN (47) environment, application programs (21), including but not limited to the gift card registry program (5) (or program modules or portions of modules) depicted relative to the server computer (2) can be contained in whole or in part in the client computer memory element (46). It is appreciated that the network connections shown are exemplary and other means of, and communications devices for, establishing a communications link between the server computer (2) and one or more client computers (6) can be used depending upon the embodiment of the invention.

Again referring primarily to FIG. 1, one or more client computers (6) can be configured to connect with one or more server computers (2) through a wide-area network (48), such as the Internet (49), or one or more local-area networks (47) to transfer corresponding images and data. As to particular embodiments, the one or more client computers (6) can take the form of a limited-capability computer designed specifically for navigation on the World Wide Web of the Internet (49). Alternatively, the one or more client computers (6) can be set-top boxes, intelligent televisions connected to receive data through an entertainment medium such as a cable television network or a digital satellite broadcast, hand-held devices such as smart phones, slate or pad computers, personal digital assistants or camera/cell phone, or multiprocessor systems, microprocessor-based or programmable consumer electronics, network personal computers, minicomputers, or the like.

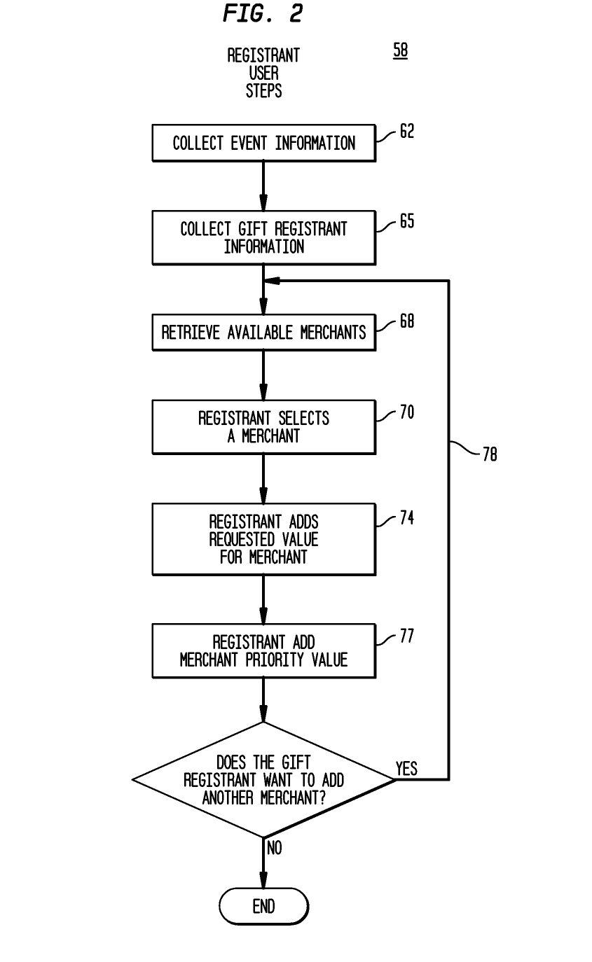

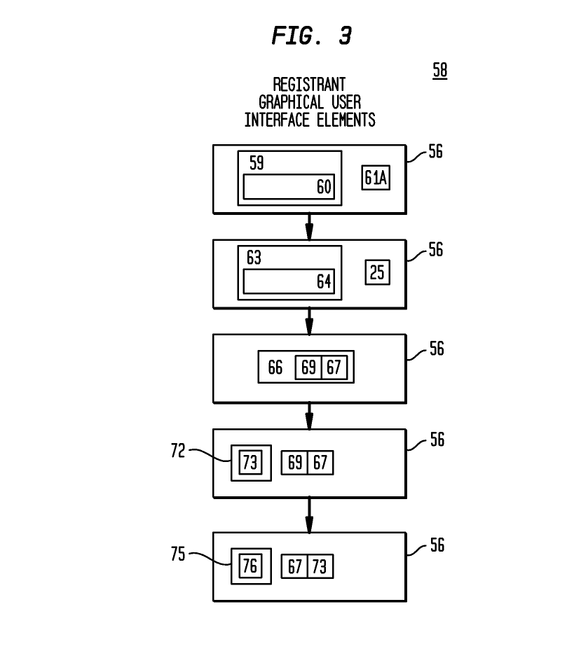

Again referring primarily to FIG. 1, each of the one or more client computers (6) can include an Internet browser (53) such as Microsoft's INTERNET EXPLORER, GOOGLE CHROME, MOZILLA FIREFOX, or the like, which functions to download and render multimedia content that is formatted in “hypertext markup language” (HTML). In this environment, the server computer (2) might be programmed to implement the most significant portions of the gift card registry program (5) including a user interactive interface (54) which as one example can be formatted and downloaded as a graphical user interface (55) having a plurality of user interactive interface elements (56) (such as screen displays or electronic pages as shown in the examples of FIGS. 3 through 5, 9 through 15, and 18). As to these embodiments, the gift card registry program (5) which implements a user interactive interface (54) including a graphical user interface (55) having one or more graphical user interactive elements (56) can be resident in the server computer (2) (as shown in the example of FIG. 1) and the one or more client computers (6) can use the Internet browser (53) to simply display downloaded content and to relay computer user (24) click events back to the server computer (2). The server computer (2) can respond by formatting one or more elements of the user interactive interface (54)(55)(56) for using embodiments of the gift card registry system (1) (as shown in the illustrative examples of FIGS. 2 through 6) and downloading the user interactive interface (54)(55)(56) for display on the display surface (37) of the one or more of the client computers (6).

In other embodiments, the one or more server computers (2) can be used primarily as sources of images and data (23), with primary responsibility for implementing the user interactive interface (54)(55)(56) being placed upon each of the one or more client computers (6). As to these embodiments, each of the one or more client computers (6) can run the gift card registry program (5) implementing the user interactive interface (54)(55)(56), to retrieve images and data (23) from the server computer (2). While illustrative examples in this description attribute a certain type of graphical format to the user interactive interface (54), it is to be understood that the user interactive interface (54) can be implemented in various formats whether graphical or non-graphical or a combination thereof and any or all of the formats of the user interactive interface (54) can reside in one or more server computers (2), one or more client computers (6), or distributed to a lesser or greater extent between a plurality of server computers (2) and a plurality of client computers (6) depending upon the embodiment of the invention. The gift card registry program (5) further operates to provide the user interactive interface (54) in a common format depending upon the request by a client computer (6).

Now referring generally to FIGS. 2 through 17, exemplary flow diagrams and exemplary user interactive interface elements (56) illustrate a stepwise method of using an on-line computer-implemented embodiment of the gift card registry system (1) utilizing a particular embodiment of the gift card registry program (5). The exemplary flow diagrams and user interactive interface elements (56) along with the stepwise description is not intended to limit the gift card registry program (5) to a fixed number of program functions or the stepwise order in which the program functions or method steps are activated or operated by the computer user (24), registrant (25) or giftor (26), rather it is intended to provide a description sufficient for a person of ordinary skill to make and use a numerous and wide variety of embodiments of the gift card registry system (1) and the gift card registry program (5).

Gift Card Registry Registrant Interface. Now referring generally to FIGS. 1 through 5, the computer user (24) can be a registrant (25). Upon a registrant inquiry (57) from a client computer (6), the server computer (2) can execute the gift card registry program (5) which functions to format and download a gift card registry registrant interface (58) including one or more user interactive interface elements (56) displayable on a display surface (37) of a display device (36) of the client computer (6) for interactive use by the registrant (25) to create a gift card registry (7) (as shown in the example of FIG. 1).

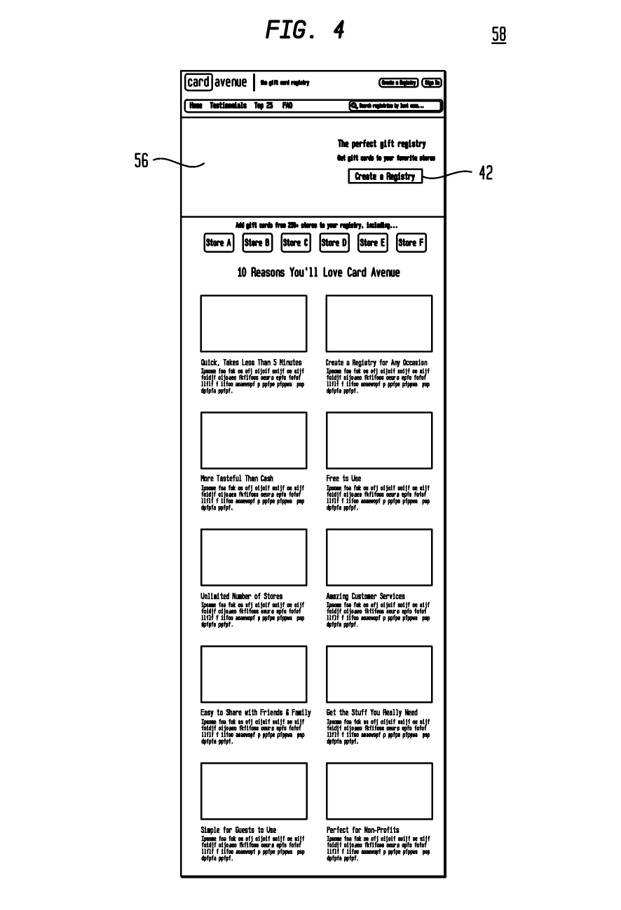

Now referring primarily to FIGS. 1 and 4, as an illustrative example, the registrant (25) can use the Internet browser (53) to download the gift card registry registrant interface (58) including a user interactive interface element (56) including an access control icon (42) (shown in the example as “Create A Registry”) which by interaction with the registrant (25) causes the server computer (2) to format and serially download additional user interactive interface elements (56) of the gift card registry registrant interface (58).

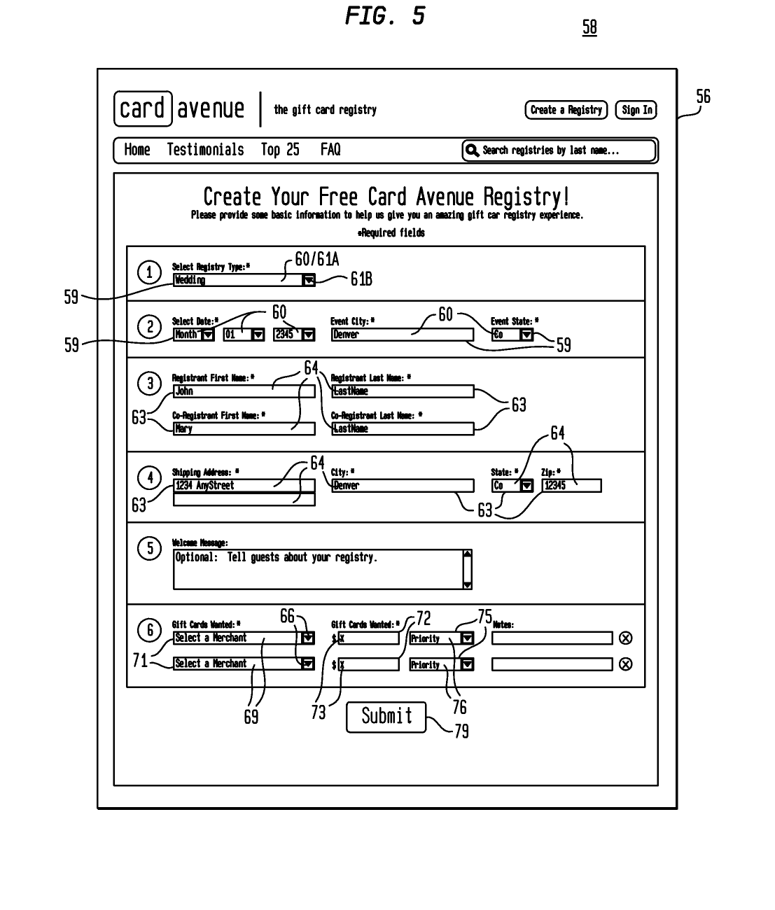

Now referring primarily to FIGS. 2 through 5, particular embodiments of the gift card registry registrant interface (58) can include a plurality of user interactive interface elements (56) serially downloaded from the server computer (2) or from the client computer (6) (as shown in the example of FIG. 3) or can include one user interactive interface element (56) downloaded from the server computer (2) or from the client computer (6) (as shown in the example of FIG. 5). Either example can include a plurality of user interactive registry event fields (59) fillable (whether entered manually by registrant (25) or by selection from drop down lists or otherwise) with registry event information (60) related to a registry event (61A) (shown as step (62) in the example of FIG. 2).

As shown in the illustrative example of FIG. 5, the registry event information field (59) can include a drop down list of registry events (61B) from which the registrant (25) can select the registry event (61A) (for example a “Wedding”) and the plurality of registry event information fields (59) can be fillable with additional registry event information (60) such as: title of the wedding event, wedding event location information, wedding event date and time information, or the like.

Upon entry of the registry event information (60), the server computer (2) can execute the gift card registry program (5) which can further function to format and download a user interactive interface element (56) displayable to provide a plurality of registrant information fields (63) fillable with registrant information (64) of registrant (25) (shown in the example of FIG. 2 as step (65)). As shown in the illustrative example of FIG. 5, the registrant information (64) can be manually entered into the registrant information fields (63) including: registrant's name, registrant's shipping address, registrant's e-mail address, registrant's login identifier, registrant's password identifier, or the like.

Upon entry of the registrant information (64), the server computer (2) can associate the registrant information (64) with the registry event (61A) and can further execute the gift card registry program (5) to function to retrieve a list of registry merchants (66) having purchasable registry gift cards (67) purchasable using the on-line gift card registry system (1) (shown in the example of FIG. 2 as step (68)). The list of registry merchants (66) can be formatted and downloaded as a user interactive interface element (56) displayable on the display surface (37) (as shown in the example of FIG. 3). The registrant (25) can by click event in the user interactive interface element (56) select one or more registry merchants (69) having purchasable registry gift cards (67) from a displayed list of registry merchants (66) to associate the registry merchant (69) with the registry event (61A) of the registrant (25) (shown in the example of FIG. 2 as step (70)).

As shown in the illustrative example of FIG. 5, a user interactive interface element (56) can include one or more registry merchant fields (71) in which the registrant (25) selects one or more registry merchants (69) having purchasable registry gift cards (67) to associate the one or more registry merchants (69) having purchasable registry gift cards (67) with the registry event (61A) of the registrant (25). As shown in the illustrative example, the registrant (25) can by click event in one or more drop down lists of registry merchants (66) select one or more registry merchants (69).

Upon selection of one or more registry merchants (69) having purchasable registry gift cards (67), the server computer (2) can further execute the gift card registry program (5) which can further function to format and download a user interactive interface element (56) which includes a corresponding registry merchant request value field (72) for each selected one or more registry merchants (69) (as shown in the example of FIG. 5) fillable by the registrant (25) with a registry merchant request value (73) to correspondingly associate the registry merchant request value (73) with each purchasable registry gift card (67) of the selected one or more registry merchants (69) (shown as step (74) in the example of FIG. 2).

As shown in the example of FIG. 5, the registrant (25) by interaction with the user interactive interface element (56) can manually enter the registry merchant request value (73) in the registry merchant request value field (72) to associate the registry merchant request value (73) with the purchasable registry gift card (67) of the selected registry merchant (69).

Upon entry of a registry merchant request value (73) to correspondingly associate the registry merchant request value (73) with each purchasable registry gift card (67) of the selected one or more registry merchants (69), the server computer (2) can further execute the gift card registry program (5) which can further function to format and download a user interactive interface element (56) which corresponding includes a registry merchant priority value field (75) for each selected one or more registry merchants (69) (as shown in the example of FIG. 3) fillable by the registrant (25) with a registry merchant priority value (76) to correspondingly associate the registry merchant priority value (76) with each purchasable registry gift card (67) of the selected one or more registry merchants (69) (shown as step (77) in the example of FIG. 2).

As shown in the example of FIG. 5, the registrant (25) by interaction with the user interactive interface element (56) can manually enter the registry merchant priority value (76) in the registry merchant priority value field (75) to associate the registry merchant priority value (76) with the purchasable registry gift card (67) of the selected registry merchant (69).

As to particular embodiments of the gift card registry registrant interface (58), the registrant (25) can decide to repeat each of steps (68) and (70) and (74) and (77) (shown as step (78) in the example of FIG. 2).

The registrant (25) can by click event of a submission element (79) in the user interactive interface element (56) submit the registry event information (60) to end the gift card registry user information input process and create the gift card registry (7) of registrant (25).

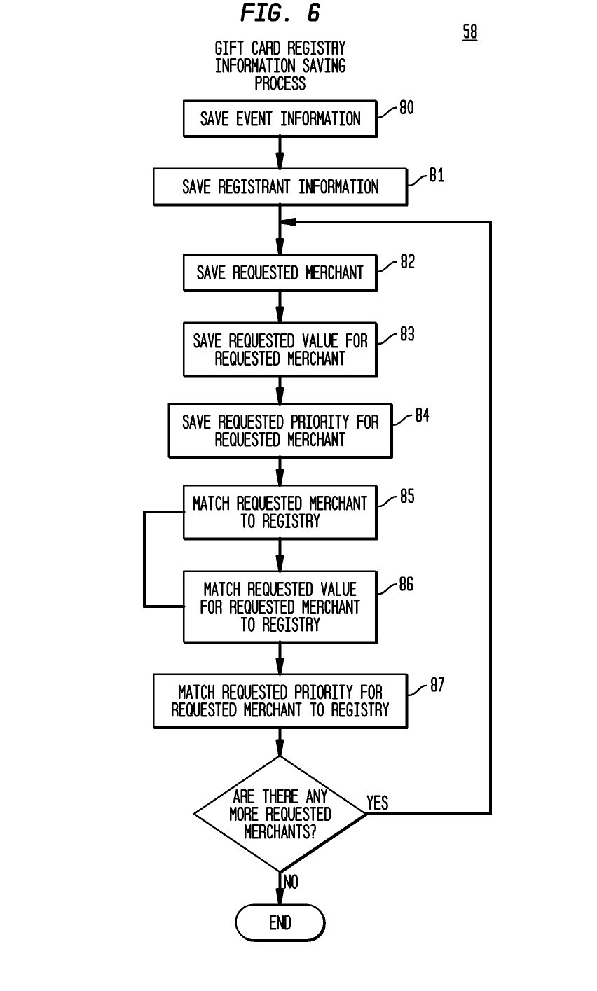

Saving Gift Card Registry Registrant Information. Now referring primarily to FIGS. 1 and 6, upon registrant (25) filling registry event information fields (59) with registry event information (60) and the registrant information fields (63) with registrant information (64) and subsequent selection of registry merchants (69) having purchasable registry gift cards (67), entry of the registry merchant request value (73) into the registry merchant request value field (72), and entry of the registry merchant priority value (76), the gift card registry program (5) can further function to correspondingly save the registry event information (60) (shown in step (80)), save the registrant information (64) (shown in step (81)), save the selected registry merchants (69) (shown in step (82)), save the selected registry merchant request value (73) (shown in step (83)), and save the registry merchant priority value (76) in a server memory element (4) of the server computer (2) (shown in step (84)).

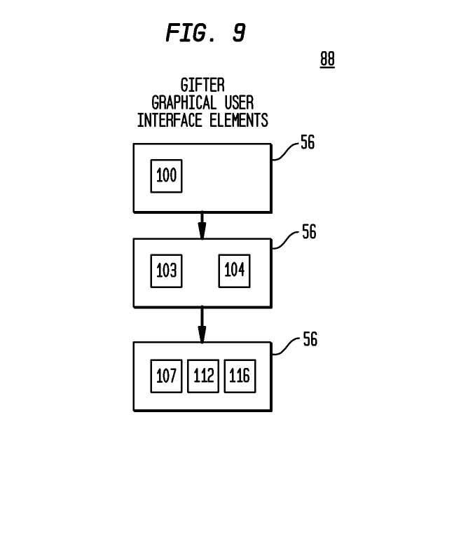

The gift card registry program (5) can concurrently or further function to associate the saved registry event information (60), the registrant information (64), the selected registry merchants (69), the registry merchant request value (73), and the registry merchant priority value (76) with the gift card registry (7) of the registrant (25) (shown as step (85), step (86), and step (87)) for use in a gift card registry giftor interface (88) which can be formatted and downloaded as one more user interactive interface elements (56) to one or more client computers (6) which can be interactive with one or more giftors (26) (as shown in the example of FIGS. 9 through 15). Upon saving the information entered by registrant (25), the gift card registry program (5) can further function to end the gift card registry information saving process.

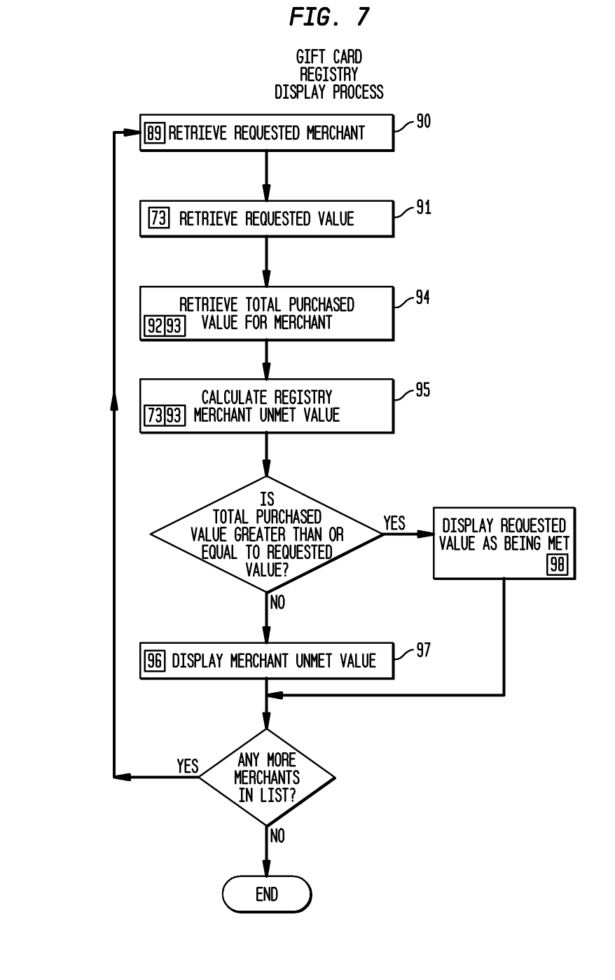

Displaying The Gift Card Registry. Now referring primarily to FIG. 7, the computer user (24) can be a giftor (26). Upon a giftor inquiry (89) from a client computer (6) (as shown in the example of FIG. 1), the server computer (2) can execute the gift card registry program (5) which functions to format and download a gift card registry giftor interface (88) including one or more user interactive interface elements (56) displayable on a display surface (37) of a display device (36) of the client computer (6) for interactive use by the giftor (26).

The gift card registry program (5) can function to retrieve the registry merchants (69) entered by the registrant (25) (shown in the example of FIG. 7 as step 90) and retrieve the associated registry merchant request value (73) entered by registrant (25) (shown as step 91 in the example of FIG. 7). The gift card registry program (5) can then function to retrieve a registry merchant purchase value (92) for each registry merchant (69) calculated by addition of the prior registry gift card purchase values (93) of already purchased registry gift cards (67) of registry merchants (69) by one or more other giftors (26) (shown in the example of FIG. 7 as step (94)). The gift card registry program (5) then functions to subtract the registry gift card purchase values (93) from the registry merchant request values (73) entered by the registrant (25) to calculate a registry merchant unmet request value (96) (shown in the example of FIG. 7 as step (95)). The gift card registry program (5) then functions display the registry merchant request unmet value (96) in the gift card registry giftor interface (88) (shown as step (97) in the example of FIG. 7).

As to particular embodiments, if a registry merchant request value (73) has a corresponding registry merchant unmet request value (96) available for purchase by the giftor (26), then the gift card registry program (5) can further function to format a downloadable a user interactive interface element (56) including the registry merchants (69) associated with the gift card registry (7) of a registrant (25) in the gift card registry giftor interface (88) with the registry merchant request value (73) displayed for comparison with the registry merchant unmet request value (96) available for purchase by one or more giftors (26) (shown in the example of FIG. 7 as step (97)).

As to particular embodiments, if the gift card registry program (5) determines that the registry merchant request value (73) entered by the registrant (25) has been already met in the entirety by one or more giftors (26) and no registry merchant unmet request value (96) remains available for purchase by a giftor (26), the gift card registry program (5) can further function to format a downloadable user interactive interface element (56) which omits or displays the requested merchant (69) in the gift card registry giftor interface (88) along with a registry merchant request met indicator (98).

As to particular embodiments, the gift card registry program (5) can function to display registry merchants (69) associated with registry merchant request values (73) and registry merchant unmet request values (96) (even if the merchant unmet request value is zero) along with a registry gift card purchase element (99), such as a shopping cart icon (115), which by user interaction allows the giftor (26) to purchase a purchasable registry gift card (67) of the selected registry merchant (69).

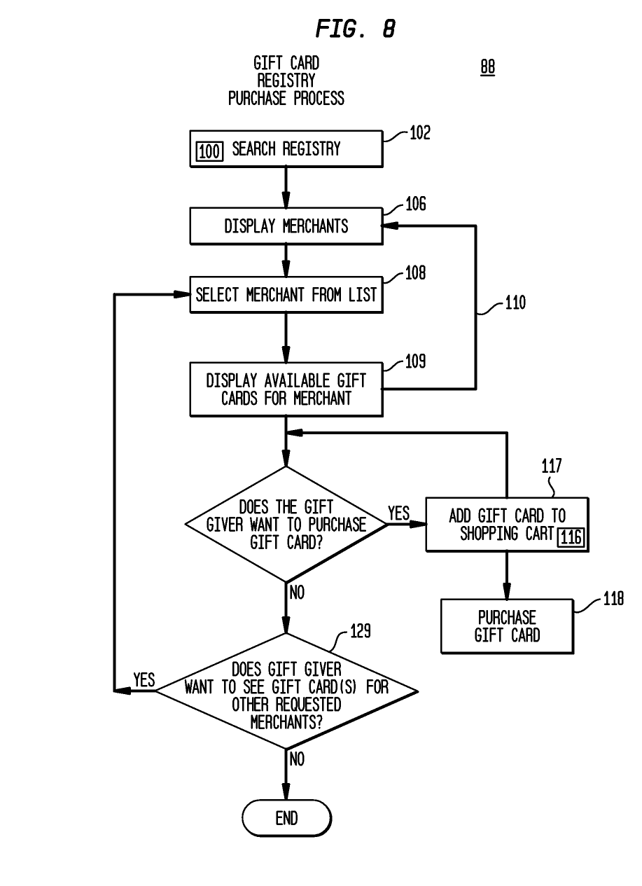

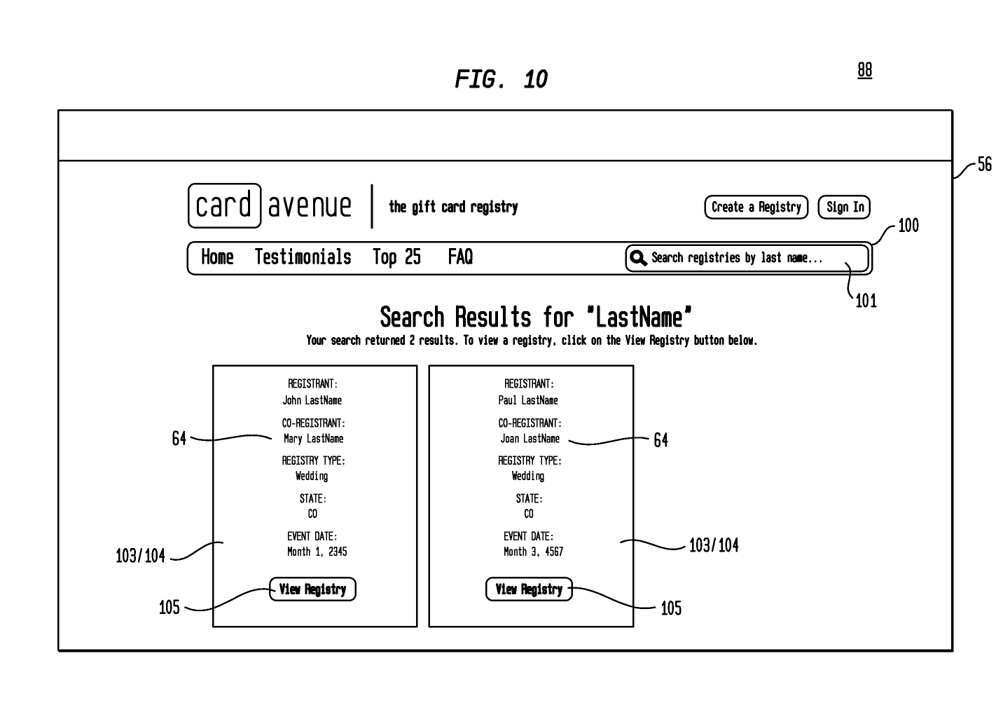

Gift Card Registry Giftor Interface. Now referring primarily to FIGS. 8 through 15, the giftor (26) can use the Internet browser (53) to download the gift card registry giftor interface (88) having one or more user interactive interface elements (56). The gift card registry giftor interface (88) can include in part a registry search field (100) (as shown in the example of FIG. 9 and in the example of FIG. 10) which by interaction with the giftor (26) to enter a registry search element (101) (such as a last name of a registrant (25)) causes the server computer (2) to search and retrieve gift card registries (7) associated with the registry search element (101) (shown in the example of FIG. 8 as step (102)). The gift cards registry program (5) can further function to format and serially download a user interactive interface element (56) including gift card registry registrant identifier (103) (shown in the example of FIG. 10 as registry information image area (104) including registry information (64) entered by registrant (25), as above described) along with an associated registry gift card selection element (105) (shown in the example as “View Registry”) for each of those gift card registries (7) associated with the registry search element (101) entered by the giftor (26).

Now referring primarily to FIGS. 8, 9 and 11, the giftor (26) can interact with the registry gift card selection element (105) to generate a giftor inquiry (89) to the server computer (2) to retrieve the selected gift card registry (7). In answer to a giftor inquiry (89) the gift card registry program (5) can further function to download and display on the display surface (37) of the client computer (6) a user interactive interface element (56) which includes a list of registry merchants (66) included in the gift card registry (7) of a registrant (25) (shown in the example of FIG. 8 as step (106)).

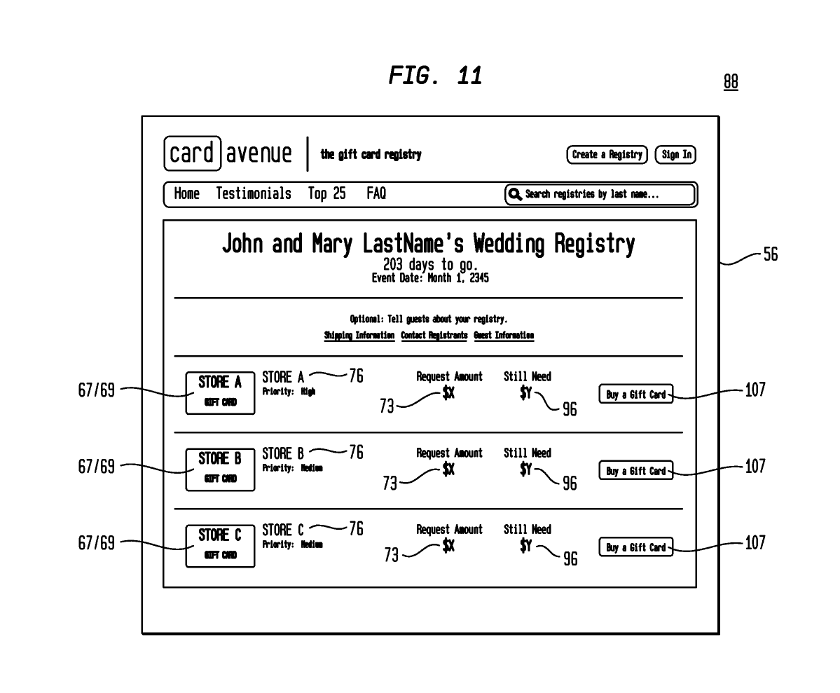

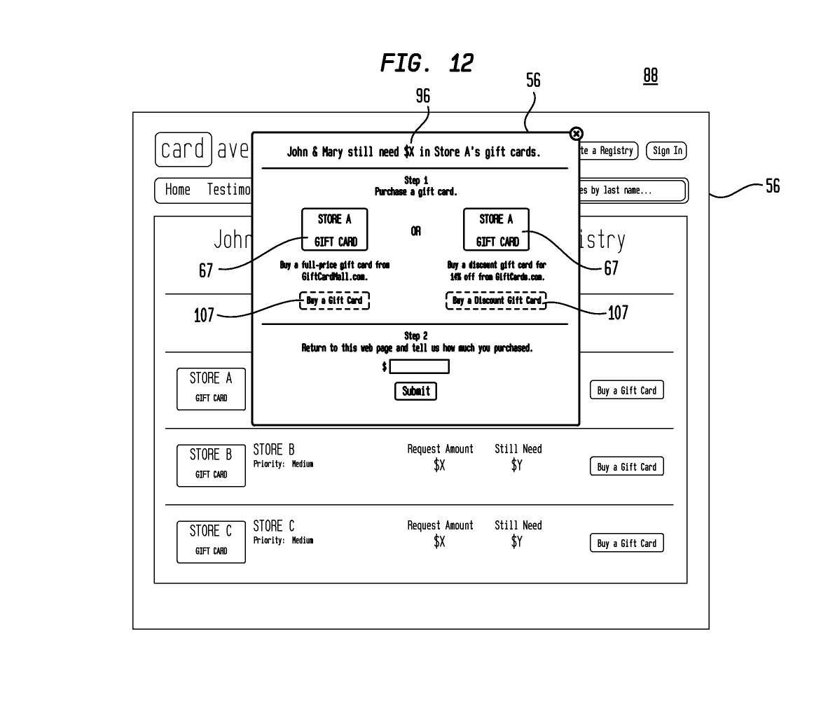

As shown in the illustrative example of FIG. 11, the registry merchants (69) associated with the gift card registry (7) of a registrant (25) can be listed each followed by the registry merchant priority value (76) and the registry merchant request value (73) and the registry merchant request unmet value (96). A registry gift card selection element (107) can be associated with each of the listed registry merchants (69). The giftor (26) can by click event of the registry gift card selection element (107) select one of the merchants (69) (shown in FIG. 8 as step (108)) to display purchasable gift cards (67) of the registry merchant (69) (shown in FIG. 8 as step (109) and as the example of FIG. 12). As to particular embodiments, if there is more than one type of purchasable registry gift card (67) associated with the selected registry merchant (69), the gift card registry program (5) can further function to format, download, and display on the display surface (37) of the client computer (6) a user interactive interface element (56) which lists the different purchasable registry gift cards (67) of the selected registry merchant (69). As shown in the illustrative example of FIG. 12, the user interactive interface element (56) can list purchasable registry gift cards (67) of a registry merchant (69) with a correspondingly associated registry gift card selection element (107) (as shown in the example of FIG. 12 where different purchasable registry gift cards (67) of a registry merchant (69) are described as “Buy A Gift Card” and “Buy A Discounted Gift Card”). In the event the giftor (26) decides not purchase the purchasable registry gift card (67) of a registry merchant (69), the giftor (26) can repeat step (106) and step (108) and step (109) (shown in FIG. 8 as step (110)).

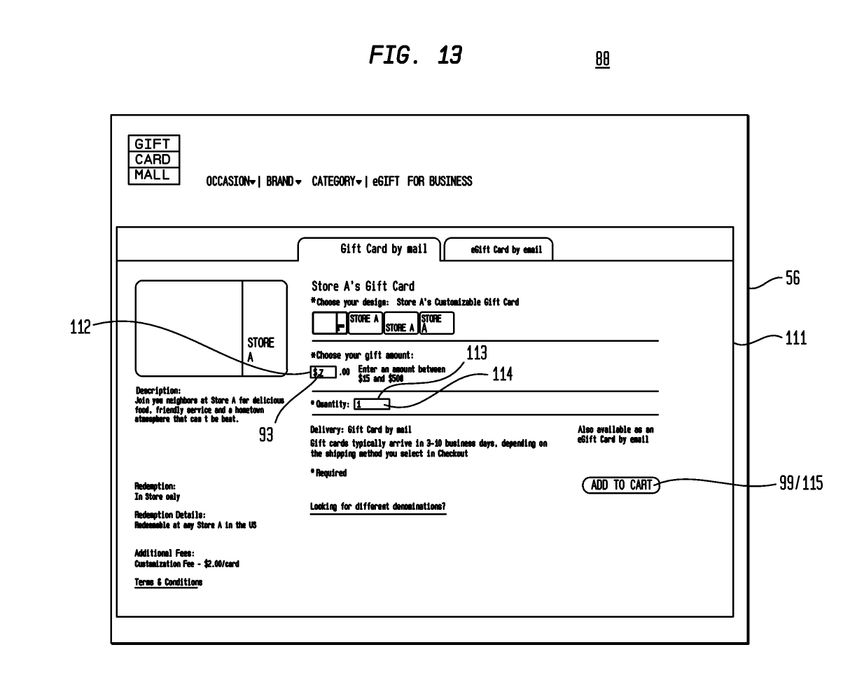

Now referring primarily to FIG. 13, as to particular embodiments, the gift card registry program (5) can further function to format, download, and display on the display surface (37) of the client computer (6) a registry gift card purchase interface (111) including a registry gift card purchase value field (112) which allows the giftor (26) to enter a registry gift card purchase value (93) to associate with the selected purchasable registry gift card (67) of the registry merchant (69). The registry gift card purchase interface (111) can further include a registry gift card purchase quantity value field (113) which allows the giftor (26) to enter a registry gift card purchase quantity value (114). The registry gift card purchase interface (111) can further include a shopping cart icon (115) which by click event associates the registry gift card purchase value (93) and the registry gift card purchase quantity value (114) with a giftor shopping cart (116) (as shown in the example of FIG. 8 as step (117)). The gift card registry program (5) can further function to format and download user interactive interface elements (56) which directs the giftor (26) to complete by click event the purchase of the selected purchasable registry gift cards (67) in the entered registry gift card purchase value (93) (shown in FIG. 8 as step (118)).

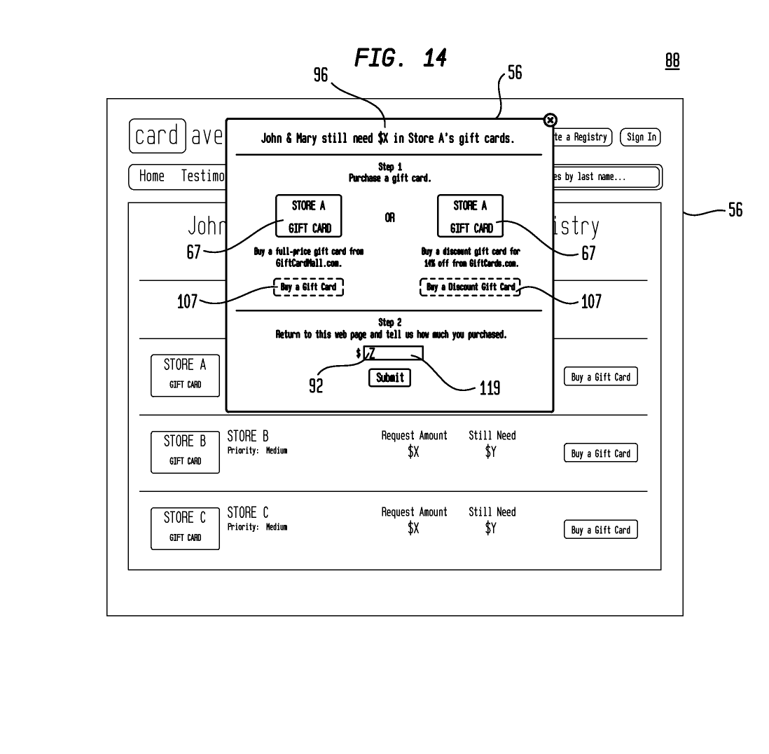

Now referring primarily to FIG. 14, as to particular embodiments, the gift card registry program (5) can further function to format and download user interactive interface elements (56) of the gift card registry giftor interface (88) including a registry gift card purchase value confirmation field (119) into which the giftor (26) can enter the registry gift card purchase value (93) of the purchased one of the purchasable registry gift cards (67).

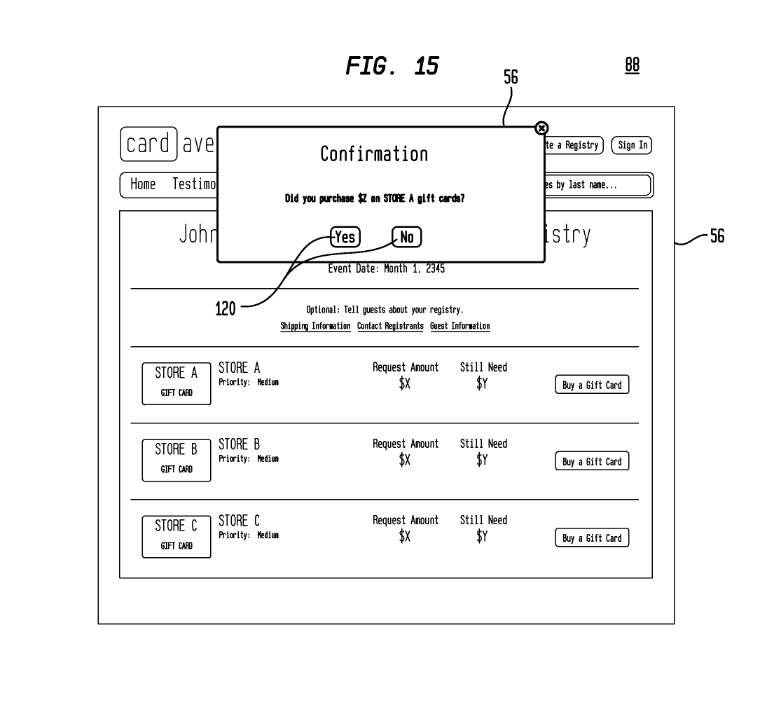

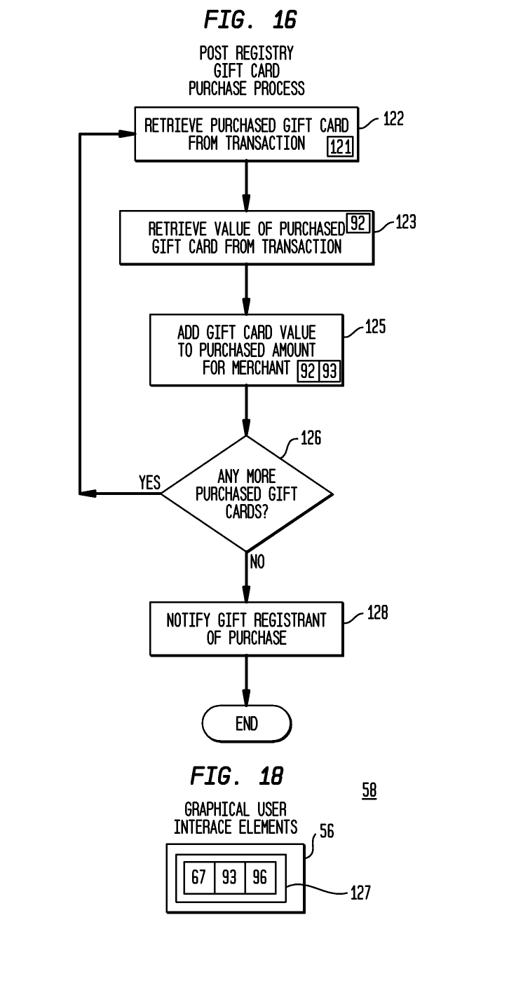

Now referring primarily to FIGS. 15 and 16, the user interactive interface elements (56) of the gift card registry giftor interface (88) can further include a registry gift card purchase value confirmation icon (120) which by click event can cause the gift card registry program (5) to further function to match each gift card purchase (121) to a corresponding gift card registry (7) with the corresponding purchasable registry gift card (67) of a registry merchant (69) included in the particular gift card registry (7) (shown in the example of FIG. 16 in step (122)). The gift card registry program (5) can further function to deduct the registry gift card purchase value (93) from the registry merchant request value (73) entered by the registrant (25) in the gift card registry (7) user information input process (shown in the example of FIG. 16 as step (123)). The gift card registry program (5) can further function to add the registry gift card purchase values (93) to the registry merchant purchase value (92) (as shown in step (125)). The gift card registry program (5) can repeat the matching process until no further registry gift card purchases (121) are found for a gift card registry (7) (shown in step (126)).

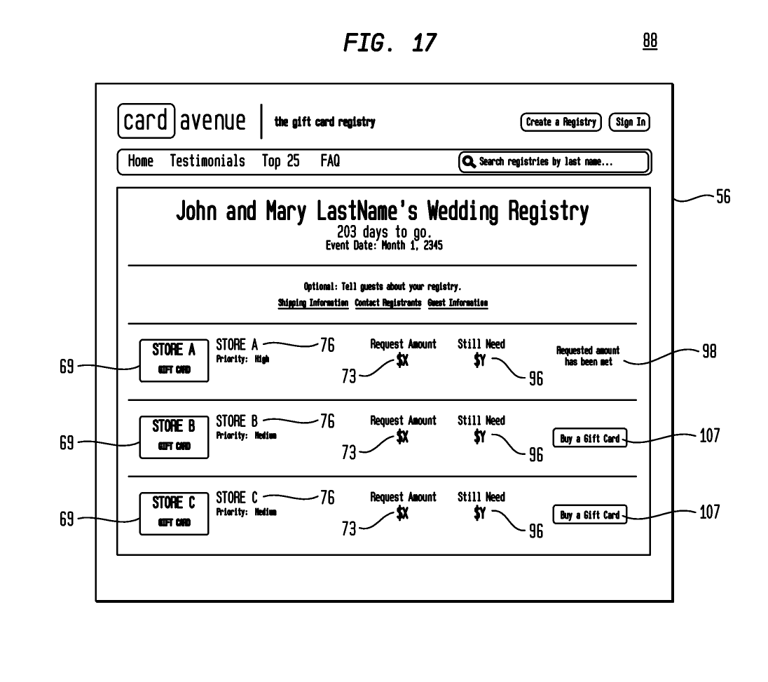

Now referring primarily FIG. 17, the gift card registry program (5) can further function to return the giftor (26) to the user interactive interface element (56) of the gift card registry giftor interface (88) which provides the list of registry merchants (66) having purchasable registry gift cards (67) (shown in the example of FIG. 8 as step 129). The gift card registry program (5) can further function to display the registry merchant request unmet value (96) reduced by the amount of the registry gift card purchase value (93) of the prior purchased registry gift cards (67). The giftor (26) can repeat step (108), step (109), step (117), and step (118) to purchase additional purchasable registry gift cards (67) of a registry merchant (69).

If the giftor (26) decides not to select addition registry merchants (69), the gift card registry program (5) can further function to end the process of using the gift card registry giftor interface (88).

Post Gift Card Purchase Process. Now referring again primarily to FIGS. 16 and 18, the gift card registry program (5) can further function to format, download, and display a user interactive interface element (56) in the gift card registry registrant interface (58) accessible by registrant (25) which provides a gift summary (127) including purchased one or more registry gift cards (67), a purchased registry gift card purchase values (93), and the registry merchant request unmet value (96) of each registry gift card (67) of each registry merchant (69) included in the gift card registry (7) of a registrant (25) (shown in the example of FIG. 16 as step (128)). Upon downloading the gift summary (127), the gift card registry program (5) can function to end the post registry gift card purchase process (129).

As can be easily understood from the foregoing, the basic concepts of the present invention may be embodied in a variety of ways. The invention involves numerous and varied embodiments of a gift card registry and methods for making and using the gift card registry including the best mode.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “registry” should be understood to encompass disclosure of the act of “registering”—whether explicitly discussed or not—and, conversely, were there effectively disclosure of the act of “registering”, such a disclosure should be understood to encompass disclosure of a “registry” and even a “means for registering.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the gift card registries herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A computer implemented gift card registry, comprising:
a memory;
a processor in communication with said memory, said memory including a computer code executable to:
depict on a display surface a gift card registry registrant interface capable of interaction with a registrant to:
select one or more registry gift cards to associate with a registry event;
create a gift card registry associated with said registrant including selected one or more registry gift cards; and
retrivably store said gift card registry associated with said registrant in a common format in a gift card registry repository of said memory.

2. The registry of claim 1, said computer code further executable to select a registry merchant request value to associate with selected said one or more registry gift cards and create a gift card registry associated with selected said registry merchant request value.

3. The registry of claim 2, wherein said gift card registry registrant interface is further capable of interaction with said registrant to select a gift card priority value associated with each selected said one or more registry gift cards.

4. The registry of claim 3, wherein said gift card registry registrant interface is further capable of interaction with said registrant to enter registry event information of a registry event.

5. The registry of claim 4, wherein said gift card registry registrant interface is further capable of interaction with said registrant to enter registrant information of said registrant to associate with said registry event.

6. The registry of claim 5, wherein said gift card registry registrant interface is further capable of interaction with said registrant to edit said gift card registry associated with said registrant.

7. The registry of claim 6, wherein said gift card registry registrant interface is further capable of interaction with said registrant to edit any of:
selected said one or more registry gift cards to associate with said registry event;
selected said registry merchant request value to associate with selected said one or more registry gift cards;
selected said gift card priority value associated with selected said one or more registry gift cards;
entered said registry event information of a registry event; and
entered said registrant information of said registrant to associate with said registry event.

8. The registry of claim 1, wherein said computer code is further executable to depict on said display surface a gift card registry giftor interface capable of interaction with a giftor to access said gift card registry of said registrant.

9. The registry of claim 8, wherein said gift card registry giftor interface is further capable of interaction with said giftor to purchase said one or more registry gift cards associated with said gift card registry of said registrant.

10. The registry of claim 9, wherein said gift card registry giftor interface concurrently depicts said merchant request value associated with each said one more registry gift cards associated with said gift card registry of said registrant and a merchant unmet request value associated with each said one or more registry gift cards associated with said gift card registry of said registrant.

11. The registry of claim 10, wherein said gift card registry giftor interface is further capable of interaction with said giftor to enter a gift card purchase value associated with each of said one or more gift cards associated with said gift card registry of said registrant.

12. The registry of claim 11, wherein said gift card registry giftor interface is further capable of interaction with said giftor to purchase said one or more registry gift cards having said gift card purchase value.

13. The registry of claim 12, wherein said gift card registry giftor interface is further capable of interaction with said giftor to confirm said gift card purchase value.

14. The registry of claim 13, wherein said computer code further executable to reduce said merchant unmet request value in an amount of confirmed said registry gift card purchase value.

15-69. (canceled)
